(19) United States
(12) Patent Application Publication
(10) Pub. No.: US 2012/0045013 A1
(43) Pub. Date: Feb. 23, 2012

(54) METHOD FOR REAL-TIME ONLINE CONTROL OF HYBRID NONLINEAR SYSTEM

(75) Inventors: Qijun CHEN, Shanghai (CN); Hao ZHANG, Shanghai (CN); Tao LIU, Shanghai (CN); Junhao LIU, Shanghai (CN)

(73) Assignee: TONGJI UNIVERSITY, Shanghai (CN)

(21) Appl. No.: 12/971,871

(22) Filed: Dec. 17, 2010

(30) Foreign Application Priority Data
Aug. 23, 2010 (CN) 201010260717.1

(51) Int. Cl. H04L 27/00

(52) U.S. Cl. 375/295

(57) ABSTRACT

The present invention provides a method for real-time online control of hybrid nonlinear system, characterized in that, it comprises the following steps: a. the current observational state of plant in the network is transmitted to first controller, where said first controller is used to provide real-time online control for plant, which guarantees the asymptotic stability of the controlled plant in the network; b. Said first controller obtains the current control output information according to the current observation state information; c. Giving said output control information to said controlled plant in the network as feedback, wherein said controlled plant in the network is nonlinear hybrid system. The present invention realizes the control of nonlinear hybrid system through network by providing control method with quantized controller to guarantee the asymptotic stability of the system. Especially, the load capacity of network will be greatly reduced by transmitting the observation information after being quantized.

### FIELD OF THE INVENTION

The present invention relates to networked control systems, especially the control methods of networked control systems, specifically involving the real-time online control method for hybrid nonlinear system.

### BACKGROUND TECHNOLOGY

With the rapid development and pervasion of computer science, network technology, communication technology, the structure of the modern control system is changing, more and more control system uses distributed control approach.

Feedback control systems wherein the control signals are transmitted through a wired or wireless communication network are called networked control systems (NCSs). NCSs are the integration of multiple technologies such as control, computer, communication and network, etc. It comes out from the need of complex large system control and remote control. It can be applied to almost any occasions that need exchange data through distributed equipments with controllers. NCSs indicate that the control systems with the development trend of networked, integrated, distributed and intelligent nodes.

Compared with the traditional control system, the NCSs have the following advantages: 1) lower cost; 2) greatly reduced cable, weight and energy consumption; 3) higher efficiency, reliability of the system; 4) the system is more flexible and is easy to be expanded; 5) simpler installation and maintenance, ease of system diagnosis; 6) ease of sharing the information resources. These advantages make the NCSs have been applied widely in industrial automation, intelligent transportation, robotics, aerospace, defense and the other areas of real-time distributed control. Therefore, the research on NCS is becomes an important part of modern control theory, and it also becomes one of the hot issues for domestic and foreign scholars and industry. It can be expected that in the next few decades, networked control will influence and push the development of modern control theory and its application. From theory aspect, the networked control will greatly promote the development of complex system control theory. From application aspect, a large number of networked systems providing a variety of complex information processing will greatly promote information technology applications of the national economy, society, defense and other fields. It will also promote the development of “information technology to stimulate industrialization” of China.

Due to introducing NCSs into the communication network, many devices connected to the network should send messages, and sending the information will occupy the network communication line time-sharing. With the constraints of limited bandwidth, limited load capacity and service capacity, congestion, collisions, retransmissions and other phenomena may occur, which inevitably bring many new challenging problems such as uncertain network-induced delay, packet loss, multiple packet transmission, jitter, clock asynchronism, etc. How can we control the whole network under the condition that we only know part of the information? What is the smallest information should we know to make it satisfy a certain performance for control?

In the NCSs modeling, the NCSs with time-vary delay has been investigated. An augmented state discrete-time NCSs model has been established for the network with characteristics of periodic time-delays. Predictor-based delay compensation problem has been solved by using buffer method. Make the design problem of NCSs convert into a common data sampling control problem by considering the networked closed-loop control system as a linear time invariant discrete control system. The controller and actuator are event-driven, and continuous plant and continuous controller have been considered by some researchers. The network-induced time-delay is considered as the error of closed-loop system, then the continuous time NCSs model has been established. The LQG optimal control problem for discrete-time NCSs with independent stochastic distribution and markovian delays has been investigated in the discrete-time domain. The optimal stochastic control method has been proposed. The network-induced delays have been divided into invariant type, independent stochastic type and markovian stochastic type, and NCSs models for each type of time-delay have been established. NCSs model for stochastic long time-delay has been established by using optimal stochastic control method. The NCSs with continuous time plant and discrete time controller has also been investigated. Network-based control system model has been established from various points of views. The cases that the time-delay is bigger and less than on sampling period have been modeled separately by the augment state method. Thus, the discrete augment state NCSs model is obtained, and the time delay compensation method is also proposed. However, the disadvantage of above existing technologies are that the network control design method comes out based on the assumption that the signal must totally be transmitted through the network and they can also be totally received. The aforementioned methods have not consider the possible missing of effective information due to the finite network bandwidth when the signal transmitted through the network. In addition, the aforementioned control methods of NCSs are all taking linear system into account, the nonlinear phenomena, which may exist in NCSs has not been considered, and the hybrid effect such as markovian jump may also exist in the NCSs.

In the aspects of research on stability, jump linear system theory, stochastic Lyapunov function, discrete-time linear augmented models combined with the traditional control stability theory, optimal stochastic control theory are the main methods adopted by most researchers. The notation of asynchronous dynamic system (ADS) has been proposed and the application in prejudice NCSs has also been investigated. The discrete time-invariant NCSs has been modeled by the switching system model, which switches between the sampling point and sampling point, then the sufficient conditions guaranteeing the stability of the system are investigated based on the model. Compared with the actual conditions, the results are conservative. By using the stable region and hybrid systems stability theory, the stability of discrete time-invariant NCSs with data dropout and multiple data transmission have been investigated with the speed constraint ADS model. The ADS models with speed constraint for these two NCSs cases have been established. The sufficient conditions for the stability analysis of these models are established by using ADS theory and hybrid system theory, and the less conservative maximum allowable time interval (MATI) is obtained by using the stable region methods, but the cases when the time-delay, multiple data packets transmission exist simultaneously are not taken into consideration. A series of results on stability, stabilization, control for NCSs have been derived by domestic and foreign experts and scholars by using the aforementioned methods or other methods. For example, the research on stability of NCSs by using linear matrix inequality (LMI) technology has been investigated, and a maximum allowable transmission time-delay and scheduling algorithm for NCSs have also been investigated. The research on NCSs fault detection method based on memoryless reduced order observer has been investigated. The research on stability of NCSs and the stabilization of NCSs with data dropout by using switching system methods have been investigated separately. The research on NCSs by using sliding mode predictive control method has also been investigated. The research on NCSs by using impulsive control method has been studied. The design of linear control system under various network environments has been investigated, which includes the realization problem of control system based on observer with data packets dropout. The research on the state feedback controller design has been investigated by using time-delay system method, and so on. All the aforementioned existing results are the ideal results based on the assumption that the signals in the network can be totally transmitted, and the limited capacity and bandwidth of the network are not considered.

As for the research on the stability of quantized feedback control system, the earliest study on quantization problem can be traced back to the study of quantization effect in sampling digital control system in 1956. Early research on the quantized feedback control is mainly focus on how to recognize and relieve quantization effect. However, the quantizer is usually regarded as the information encoder in the recent study. The intention of the research is to get how much information has to be transmitted through the quantizer to guarantee the control performance of the close-loop system. There are many important research results on this area. Among these results, there are mainly two kinds of methods for the quantized feedback control. The first method is to use the feedback memoryless feedback quantizer, which is often called static quantization strategy. The static quantization strategy assumes that the data to be quantized at instant k only has related to the data at instant k, and thus the structure of encoding/decoding strategy is relatively simple. The mathematical explanation of unified quantized feedback control system is given by the existing technology, and then the quantity of quantization interval to stabilize a linear system is provided. The second method is to take the quantized feedback controller as the inner state of the system, and the quantizer maybe dynamic and time-varying. This method have many advantages in that increasing the attraction domain and reducing stable state limit cycle can dynamic characterization of quantization levels. However, the dynamic quantized feedback control only use on discussing the stabilization problem of system. Due to lacking of a unified method or frame to deal with more complicated situation, and thus the discussion on the control performance has not been taken.

For the feedback control of static quantizer, the quadratic stabilization problem of discrete SISO linear time invariable system has been investigated through state quantized feedback in the static quantized feedback domain. The research result shows that the quantizer needs to be in logarithm form for the quadratic stabilization system. Recently, the method of sector bounded has been applied into the research of quantized feedback control, and the research on feedback system with logarithmic quantizer has been intensively investigated. The comprehensive and practical results for SISO and MIMO linear discrete-time systems are given separately.

In addition, the stabilization and control performance (Including the guaranteed cost control and H_infinity control) have been discussed in a unified frame. However, only one quantizer case is considered in the mentioned technology, and when the effects of network time-delay, data packets dropout have been taken into consideration, these methods can not be applied into NCSs directly. The guaranteed control problem of continuous NCSs with quantized state, quantized input, network-induced time delay and data packets dropout has also been investigated. But the technology is based on the continuous time system model. Generally speaking, the network only takes action and transmits information at some certain discrete time instants, so the hybrid NCSs model is more close to the practical situation.

For the research on nonlinear system, fuzzy control is a very effective method. The T-S fuzzy model is first proposed in 1985. T-S fuzzy system is a universal approximator of nonlinear systems, and it can close to a nonlinear system at arbitrary precision. It is a very effective method for the research on nonlinear system. Therefore, the analysis, control synthesis of T-S fuzzy system have attracted much attention since the T-S fuzzy model has been proposed. For example, the stability and stabilization of T-S fuzzy system has been investigated by the existing technology. The H_infinity controller design of T-S fuzzy system has also been investigated, and the filtering problem of T-S fuzzy system has also been investigated. It is noted that most of the existing results derived by using single Lyapunov function method and it is neither taking network as the typical nonlinear object, no considering the effects on the modeling and analysis of more complex network specific factors. However, the main drawback of this method is that a single Lyapunov function needs to apply in all subsystems, which will lead to conservative results.

Since most NCSs model are discrete or hybrid model, the state of the network may not be measured directly and it is obtained by using the observer due to the complex environments. The capacity and bandwidth of network are limited, so the information must be selected by some strategies to transmit for control. Up to now, there are few results on modeling and quantized control for nonlinear time-delay hybrid NCSs. There have certain theoretic meanings in modeling of characteristics the network and quantized feedback controller design with more taking network environment factors and into consideration. The research results will provide the theory foundation to build the high performance network.

### SUMMARY OF THE INVENTION

For the shortcomings of the existing technology, the intention of the present invention is to provide a method for real-time online control of hybrid nonlinear system.

According to one aspect of the present invention, to provide a method for real-time online control of hybrid nonlinear system, characterized in that, it comprises the following steps: a. The current observation state information of controlled plant in the network will be transmitted to the first controller, wherein said first controller is used to provide real-time online control, which guarantees the asymptotic stability of the controlled plant in the network; b. Said first controller obtains the current control output information according to the current observation state information; c. Giving said output control information to said controlled plant in the network as feedback, wherein said controlled plant in the network is a nonlinear hybrid system.

On the other side, the present invention provides a real-time online control system of hybrid nonlinear system, it comprises the first controller, wherein said first controller is used to provide real-time online control, which guarantees the asymptotic stability of the controlled plant in the network; characterized in that, it further comprises sensor, observer, the first quantizer, the first encoder and the first decoder, which are connected in series between the output of the controlled plant in the network and the input of said first controller, and it further comprises second quantizer, second encoder, second decoder and said actuator, which are in series connected between the output of said first controller and the input of the controlled plant in the network, wherein said observer is used to observe the state information of the system with the measurable output of the system, said first quantizer is used to quantize the information which is transmitted in the network from said sensor to said first controller side with the quantization factor, said second quantizer is used to quantize the information which is transmitted in the network from said first controller to said actuator side with the quantization factor.

The present invention provides a quantized control method to realize the control of the nonlinear hybrid system through network, which guarantees the asymptotic stability of the controlled plant in the network. Considering the state of the plant cannot be measured directly but the output of the plant can be measured, the present invention provides a quantized feedback controller based on observer output. The control design comprises observer gain, observation state feedback controller gain, time-varying quantization factor and quantization range. For considering the reason of the capacity and load limitation of network, the information transmitted to the controller is the limited information by being quantized but not the complete information. The advantages of the present invention are that the structure is simple, the design is convenient, the parameters of the quantizer can be adjusted on-line according the state, and it can provide real time on-line control to the plant.

Advantages and beneficial effects of the present invention are as the following:

1) The control object is a kind of nonlinear hybrid system consisting of hybrid properties, which can represent more general features of the actual control object. Here, the T-S fuzzy model with state impulsive is employed to describe it.

2) The designed observer gain can make the observer to observe the state of system according to the output of plant. The input of controller is the observation state. This method is more suitable for the system with complex structure and the state of the system can not be measured directly.

3) The designed controller is more suitable for network transmitting. The designed controller of the present invention can adjust the parameters of quantizer on real time, and it can transmit the observation information after quantization, which can lighten the load of network.

4) The quantizers which be installed on the sensor side and output of controller side can select different quantization algorithms and they can be adjusted flexible.

### DESCRIPTIONS OF THE DRAWINGS

By reading the detail descriptions of the non-restrictive implementation of the following figures, the other features, purpose and advantages of the present invention will become more apparent:

FIG. 1 shows the structure of the nonlinear hybrid networked control system according to the first case of the invention; And

FIG. 2 shows the simulation figure of the nonlinear hybrid network uses the real time on-line control method mentioned above according to a specific implementation approach of the invention.

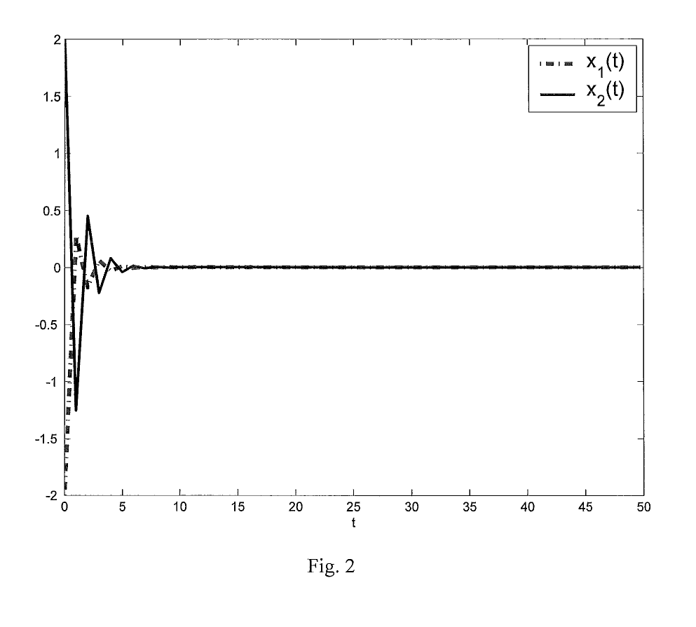

FIG. 3 is a flow chart showing the steps in the control method of the control system.

### DETAILED DESCRIPTION

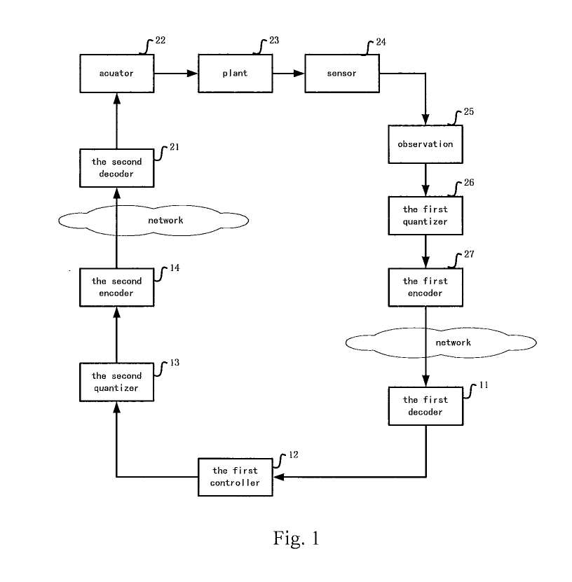

FIG. 1 shows the structure of the nonlinear hybrid networked control system according to the first case of the invention. The control system of the invention comprises first controller 12, wherein said controller 12 is used to provide real-time on-line control for controlled plant 23 in the network and it guarantees plant 23 asymptotically stable, characterized in that, it comprises series sets from output of plant 23 in the network to input of first controller 12, which including sensor 24, observer 25, first quantizer 26, first encoder 27, first decoder 11, it also comprises series sets from output of said controller 12 to input of plant 23 in the network, which including second quantizer 13, second encoder 14, second decoder 21 and actuator 22, where, said observer 25 is used to obtain the observational state information of plant by the measurable output of system, and said first quantizer 26 is used to quantize the information which is transmitted in the network from said sensor 24 to said first controller 12 side with the quantization factor, said second quantizer 13 is used to quantize the information which is transmitted in the network from said first controller 12 to said actuator 22 side with the quantization factor.

In a preferable embodiment of the present embodiment, the quantization factor of said first quantizer 26 is different from the quantization factor of said second quantizer 13. Preferably, said first quantizer 26 is a logarithmic quantizer and said second quantizer 13 is a time-varying quantizer. Furthermore preferably, said sensor 24 is time-driven, while said first controller 12 and said actuator 22 are event-driven. Said first quantizer 26 quantizes said current state information and transmits part of the current state information into network. Said observational state information includes first parameters, where said first parameters include: fuzzy sets; Premise variables for the continuous-time part of the state space equation; Premise variables for the discrete-time part of the sate space equation; The state space equation of the system; The control input of the system; The controlled output of the system; The impulsive magnitude of the system; The impulsive instants of the system; Quantization range of the quantizer; and Quantization error of the quantizer.

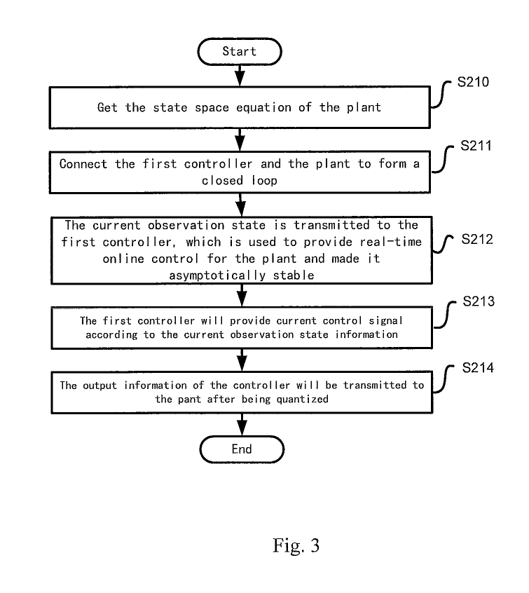

The embodiment shown in FIG. 1 shows the structure of said control system. Next, FIG. 3 describes the control method of said control system. Specifically, in the embodiment shown in FIG. 3, the first step is S210, getting state space equation of the plant in said network, where said plant in the network is nonlinear hybrid system. In a preferable embodiment, the state space equation of said plant in the network can be described by:

For the continuous-time part

Rule

if θ₁(t) is Mᵢ₁, . . . , θ_{g}(t) is M_{ig}

then

\dot{x}(t)=Aᵢx(t)+Fᵢu(t),

y(t)=Cx(t),

where iεS={1, 2, . . . , r}, r is IF-THEN rules. Mᵢⱼ is fuzzy set, θ₁(t), . . . , θ_{g}(t) is the premise variable of continuous part, x(k)εRⁿ is the state of system, u(k)εR^{m} is the control input of system, y(t)εR^{q} is the controlled output, Aᵢ,Fᵢ are known constant matrices.

For the discrete time part

Rule i

If θ₁(tₖ) is Mᵢ₁, . . . θ_{g}(tₖ) is M_{ig}

then

x(tₖ⁺)=(I+Eₖᵢ)x(tₖ)

where θ₁(tₖ), . . . , θ_{g}(tₖ) is the premise variable of discrete time part. Hybrid effects are represented by a series of impulsive effects and the impulsive instant tₖ satisfies 0≦t₀<t₁<t₂< . . . <tₖ< . . . .

According to the switching signal, the system switches between a series of linear systems which can represent nonlinear system. Since the impulsive effects exist in the system in discrete time instants, then the state of the system is continuous changes and discrete jump alternately.

Preferably, said step S210 comprises “getting the gain matrices of said first controller and said observer”. Specifically,

Assumption 1: t₀=0, h>0 is sufficiently small scalar satisfies lim_{h→0}_{^{−}}x(tₖ−h)=x(tₖ⁻), lim_{h→0}_{⁺}x(tₖ+h)=x(tₖ⁺) and x(tₖ)=lim_{h→0}_{⁺}x(tₖ−h).

Assumption 2: tₖ₊₁−tₖ≦τ, k=0, 1, 2, . . . , scalar τ is composed of time-delay from said sensor to said first controller and time-delay from said first controller to said actuator.

The said first quantizer and/or the said second quantizer installed on the both sides of said sensor and said first controller is time-varying quantizer.

Assumption 3: if there exists positive scalar T and A satisfies the following inequalities

If ∥z∥≦T then ∥q(z)−z∥≦Δ

If ∥z∥>T then ∥q(z)∥>T−Δ

where T and Δ are the quantization range and quantization error of time-vary quantizer separately. Here we use

$$q ( z ) = μ q ( \frac{z}{μ} ) ,$$

μ<0 quantization of the states, μ is zoom parameter factor of quantizer, quantization satisfies the following conditions

If ∥z∥≦μT then

$$‖ μ q ( \frac{z}{μ} ) - z ‖ \leq μΔ$$

If ∥z∥>μT then

$$‖ μ q ( \frac{z}{μ} ) ‖ > μ ( T - Δ )$$

The designed output-based observer is

for the continuous-time part

Rule i

If θ₁(t) is Mᵢ₁, . . . θ_{g}(t) is M_{ig}

Then \hat{x}(t)=Aᵢ\hat{x}(t)+Fᵢu(t)+Lᵢ(y(t)−ŷ(t))

for the discrete-time part

Rule i

If θ₁(tₖ) is Mᵢ₁, . . . θ_{g}(tₖ) is M_{ig}

Then \hat{x}(tₖ⁺)=(I+Eₖᵢ)\hat{x}(tₖ)

the quantized output feedback controller is

Rule i

If θ₁(t) is Mᵢ₁, . . . θ_{g}(t) is M_{ig}

Then

$$u ( t ) = {μ}_{2} {q}_{2} ( \frac{{K}_{i} {μ}_{1} {q}_{1} ( {x}^{⋒} ( t - τ ) / {μ}_{1} )}{{μ}_{2}} )$$

where q₁(·), q₂(·) are the quantizes added into both sides of sensor and actuator.

The change of quantization factor of quantizer on the controller side depends on the quantization factor of quantizer on sensor side. In order to transmit quantization factor from u₁ to u₂, a logarithmic quantizer is used here to realize parameter transmission due to alleviating the load of network.

The logarithmic quantizer have the following properties and the quantization level of the logarithmic quantizer is defined as follows

U={uᵢ=ρⁱu₀, i=0, ±1, ±2, . . . }

where ρ is density of quantization. The logarithmic quantizer is given by

$$g ( α ) = \{ \begin{matrix}{u}_{i} , & \frac{1}{1 + {δ}_{g}} {u}_{i} < α \leq \frac{1}{1 - {δ}_{g}} {u}_{i} \\ 0 , & α = 0 \\ - f ( - α ) , & a < 0\end{matrix} , where {δ}_{g} = \frac{1 - ρ}{1 + ρ} .$$

g( μ̅₁)=(1+Δ_{g}) μ̅₁, |Δ_{g}|≦δ_{g}, μ₁, μ₂ are defined as μ₁=g( μ̅₁),

$${μ}_{2} = \frac{1}{θ} {μ}_{1} , θ > 0.$$

In order to design said first controller gain matrix Kᵢ and said observer (here, output observer preferably) gain matrix Lᵢ. By introducing Lyapunov function V₁(t)=Xₑ(t)′ R̅Xₑ(t), V₂(t)=∫_{t-τ}^{t}Xₑ(s)′ Q̅Xₑ(s)ds, V₃(t)=∫_{-τ}⁰∫_{θ+t}^{t}Xₑ(s)′ R̅Xₑ(s)ds and getting the fuzzy output feedback controller and said output-based observer to meet the requirements. Said first controller is obtained by solving a set of first linear matrix inequalities, the process is as follows:

Condition 1:

For given matrices W₁>0, W₂>0, positive scalars θ, Δ₁, Δ₂, if there exist matrices \tilde{X}, \tilde{Y}, X₁₁, X₁₂, X₂₂, Y₁₁, Y₁₂, Y₂₂, R>0, Q>0 satisfy

Mᵢᵢ<0, Mᵢⱼ+Mⱼᵢ<0, 1≦i<j≦r

\tilde{M}ᵢᵢ<0, \tilde{M}ᵢⱼ+\tilde{M}ⱼᵢ<0, 1≦i<j≦r

where

$${M}_{ii} = [ \begin{matrix}{RA}_{i} + {A}_{i}^{T} R + Q & {C}^{T} {\tilde{Y}}_{i}^{T} & 0 & {F}_{i} {\tilde{X}}_{i} \\ * & {RA}_{i} + {A}_{i}^{T} R - {\tilde{Y}}_{i} C - {C}^{T} {\tilde{Y}}_{i}^{T} + Q & 0 & {F}_{i} {\tilde{X}}_{i} \\ * & * & - Q & 0 \\ * & * & * & - Q\end{matrix} ] < - {W}_{1}$$

$${M}_{ij} = [ \begin{matrix}{RA}_{i} + {A}_{i}^{T} R + Q & {C}^{T} {\tilde{Y}}_{j}^{T} & 0 & {F}_{i} {\tilde{X}}_{j} \\ * & {RA}_{i} + {A}_{i}^{T} R - {\tilde{Y}}_{j} C - {C}^{T} {\tilde{Y}}_{j}^{T} + Q & 0 & {F}_{i} {\tilde{X}}_{j} \\ * & * & - Q & 0 \\ * & * & * & - Q\end{matrix} ] < - {W}_{1}$$

$${\tilde{M}}_{ii} = [ \begin{matrix}\begin{matrix}{RA}_{i} + {A}_{i}^{T} R + τ {X}_{11} + \\ {Y}_{11} + {Y}_{11}^{T} + Q\end{matrix} & {C}^{T} {\tilde{Y}}_{i}^{T} + τ {X}_{12} + {Y}_{12} + {Y}_{21}^{T} & - {Y}_{11} & {F}_{i} {\tilde{X}}_{i} - {Y}_{12} & τ {A}_{i}^{T} R & τ {C}^{T} {\tilde{Y}}_{i}^{T} \\ * & {RA}_{i} + {A}_{i}^{T} R - {\tilde{Y}}_{i} C - {C}^{T} {\tilde{Y}}_{i}^{T} & - {Y}_{21} & {F}_{i} {\tilde{X}}_{i} - {Y}_{12} & 0 & τ {A}_{i}^{T} R - τ {C}^{T} {\tilde{Y}}_{i}^{T} \\ * & * & - Q & 0 & 0 & 0 \\ * & * & * & - Q & τ {\tilde{X}}_{j}^{T} {F}_{i}^{T} & τ {\tilde{X}}_{j}^{T} {F}_{i}^{T} \\ * & * & * & * & - τ R & 0 \\ * & * & * & * & * & - τ R\end{matrix} ] < - {W}_{2}$$

$${\tilde{M}}_{ij} = [ \begin{matrix}\begin{matrix}{RA}_{i} + {A}_{i}^{T} R + τ {X}_{11} + \\ {Y}_{11} + {Y}_{11}^{T} + Q\end{matrix} & {C}^{T} {\tilde{Y}}_{j}^{T} + τ {X}_{12} + {Y}_{12} + {Y}_{21}^{T} & - {Y}_{11} & {F}_{i} {\tilde{X}}_{j} - {Y}_{12} & τ {A}_{i}^{T} R & τ {C}^{T} {\tilde{Y}}_{j}^{T} \\ * & {RA}_{i} + {A}_{i}^{T} R - {\tilde{Y}}_{j} C - {C}^{T} {\tilde{Y}}_{j}^{T} & - {Y}_{21} & {F}_{i} {\tilde{X}}_{j} - {Y}_{12} & 0 & τ {A}_{i}^{T} R - τ {C}^{T} {\tilde{Y}}_{j}^{T} \\ * & * & - Q & 0 & 0 & 0 \\ * & * & * & - Q & τ {\tilde{X}}_{j}^{T} {F}_{i}^{T} & τ {\tilde{X}}_{j}^{T} {F}_{i}^{T} \\ * & * & * & * & - τ R & 0 \\ * & * & * & * & * & - τ R\end{matrix} ] < - {W}_{2}$$

Condition 2:

$$\begin{matrix}min β \\ [ \begin{matrix}- β I & {( {RF}_{i} - {F}_{i} {R}_{0} )}^{T} \\ * & - I\end{matrix} ] < 0\end{matrix}$$

Condition 3: the zoom factor \tilde{μ}₁ of quantizer added into sensor side satisfies second inequality

$$( 1 + {δ}_{g} ) max \{ {\overline{T}}_{1} , {\overline{T}}_{2} \} \leq \frac{‖ \hat{x} ( t ) ‖}{{\overline{μ}}_{1}} \leq ( 1 - {δ}_{g} ) {T}_{1}$$

where T̅₁=2∥ R̅Cₑ∥∥W₁⁻¹∥Δ, T̅₂=(τ∥W₂⁻¹∥∥φ∥+\sqrt{τ²∥W₂⁻¹∥²∥φ∥²+∥Cₑ^{T} R̅Cₑ∥∥W₂⁻¹∥})Δ, the ranges of quantizer are

$${T}_{1} \geq max \{ \overline{{T}_{1}^{′}} , \overline{{T}_{2}^{′}} \} , \overline{{T}_{1}^{′}} = \frac{1 + {δ}_{g}}{1 - {δ}_{g}} {\overline{T}}_{1} , \overline{{T}_{2}^{′}} = \frac{1 + {δ}_{g}}{1 - {δ}_{g}} \overline{{T}_{2}} , \\ {T}_{2} = θ {max}_{i ∈ S} ‖ {K}_{i} ‖ ( {T}_{1} + {Δ}_{1} ) , R = diag \{ R , R \} , \\ Δ = \sqrt{{Δ}_{1}^{2} + \frac{1}{{θ}^{2}} {Δ}_{2}^{2}} , ϕ = [ \begin{matrix}{A}_{e}^{T} \overline{R} {C}_{e} \\ {B}_{e}^{T} \overline{R} {C}_{e}\end{matrix} ] , {A}_{e} = [ \begin{matrix}{A}_{i} & 0 \\ {L}_{i} C & {A}_{i} - {L}_{i} C\end{matrix} ] , \\ {B}_{e} = [ \begin{matrix}0 & {F}_{i} {K}_{i} \\ 0 & {F}_{i} {K}_{i}\end{matrix} ] , {C}_{e} = [ \begin{matrix}{F}_{i} {K}_{i} & {F}_{i} \\ {F}_{i} {K}_{i} & {F}_{i}\end{matrix} ] .$$

Condition 4:

$${\sum }_{k = 0}^{∞} {d}_{k} < ∞ where {d}_{k} = \vert {max}_{i ∈ S} \{ {λ}_{max} ( {\overline{R}}^{- 1} {E}_{e}^{T} \overline{R} {E}_{e} ) + 2 {λ}_{max} ( {E}_{e} ) \} \vert , \\ {E}_{e} = [ \begin{matrix}I + {E}_{ki} & 0 \\ 0 & I + {E}_{ki}\end{matrix} ] .$$

When the conditions from 1 to 4 are satisfied, said first controller (here, fuzzy controller preferably), then the gain of first controller can be derived as

Kᵢ=R₀⁻¹\tilde{X}ᵢ.

Said observer (here, output-based observer preferably) gain can be derived as

Lᵢ=R⁻¹\tilde{Y}ᵢ

After getting the state space equation of plant in the network by step S210, then connects said first controller and said plant in the network to form a closed-loop system by step S211. Specifically, as FIG. 1 shows that said hybrid nonlinear networked control system is composed of plant, said first controller and the network, where said plant in the network side comprises second decoder 21, actuator 22, plant 23 in the network, sensor 24, observer 25, first quantizer 26 and first encoder 27. Said first controller side comprises first encoder 11, first controller 12, second quantizer 13 and second encoder 14. More specifically, said plant 23 in the network transmits the current observation state information to said first controller 12 through said sensor 24, said observer 25, first quantizer 26, first encoder 27 and first decoder 11 in turn. Said first controller 12 transmits the said controlled output information to plant 23 in the network through second quantizer 13, second encoder 14, second decoder 21 and said actuator 22 in turn, where the current observation state information comprises the current measured output information. Preferably, said observer 25 is used to obtain the observation state information of system through the measurable output of system. Said first quantizer 26 is used to quantize the information which is transmitted in the network from said sensor 24 to said first controller 12 side with the quantization factor. It selects the information according to the change of quantization factor of quantizer and thus reduces the quantity of the information to be transmitted. Said second quantizer 13 is used to quantize the information which is transmitted in the network from said first controller 12 to said actuator 22 side with the quantization factor. It selects the information according to the change of quantization factor of quantizer and thus reduces the quantity of the information to be transmitted. The technician in this field can realize the said closed-loop system by considering FIG. 1 and here we will not discuss it in details.

Next, step S212 is executed. The current observational state information of said plant in the network transmits to first controller, where said first controller is used to provide online real-time control to guarantee the asymptotic stability of the plant in the network. Specifically, in a preferable embodiment, said current state information includes first parameters information, where said first parameters include: fuzzy sets, premise variables for the continuous-time part of the state space equation, premise variables for the discrete-time part of the sate space equation, the state space equation of the system, the control input of the system, the controlled output of the system, the impulsive magnitude of the system, the impulsive instants of the system, quantization range of the quantizer and quantization error of the quantizer.

More specifically, firstly, first parameter information of the plant in the network is transmitted to said observer though said sensor. Since the state of practical plant can not be measured directly easily, but the output of system can be measured easily, so said observer is used to observe the state information of plant through the measurable output of plant. Then, said observer transmits said first parameter information after being quantized to said first quantizer. Next, said first quantizer transmits said first parameter information after being quantized to said first controller through said first encoder and first decoder in turn. Preferably, said first quantizer is a logarithmic quantizer and said second quantizer is a time-vary quantizer. Preferably, said sensor is time-driven, and said first controller and said actuator are event-driven. Preferably, said first quantizer quantizes the current state information and selects part of the current state information to transmit them into the network.

Then, step S213 is executed continuously, said first controller obtains the current control output information according to said current observational state information. Specifically, solving first linear matrix inequalities according to said state space equation and said first parameter information, we get the corresponding gain matrices of said first controller and said observer, wherein said state space equation and first linear matrix inequalities can be realized by considering said step S210, here we will not discuss it in details. Then, we can get the change information of quantization zoom factor of said first quantizer according to second inequality constraint and transmit it to the zoom factor of second quantizer.

The change of quantization factor of quantizer on the controller side depends on the quantization factor of quantizer on sensor side. In order to transmit quantization factor from μ₁ to μ₂, a logarithmic quantizer is used here to realize parameter transmission due to alleviating the load of network.

The logarithmic quantizer has the following properties and the quantization level of the logarithmic quantizer is defined as follows

U={uᵢ=ρⁱu₀, i=0, ±1, ±2, . . . }

where ρ is density of quantization. The logarithmic quantizer is given by

$$g ( α ) = \{ \begin{matrix}{u}_{i} , & \frac{1}{1 + {δ}_{g}} {u}_{i} < α \leq \frac{1}{1 - {δ}_{g}} {u}_{i} \\ 0 , & α = 0 \\ - f ( - α ) , & a < 0\end{matrix} , where {δ}_{g} = \frac{1 - ρ}{1 + ρ} .$$

g(μ₁)=(1+Δ_{g}), |Δ_{g}|≦δ_{g}, μ₁, μ₂ are defined as μ₁=g( μ̅₁),

$${μ}_{2} = \frac{1}{θ} {μ}_{1} , θ > 0.$$

Finally, step S214 is executed and said control output information of transmits to said plant in network as feedback. Specifically, said control output information quantized by second quantizer is transmitted to said actuator successively through said second encoder and said second decoder. Preferably, the quantization factor of said first quantizer is different from that of said second quantizer.

Furthermore, in the sequel sampling period, the online real-time control of said plant in the network can be realized by repeating step S212, step S213 and step S214.

In the preferable embodiment of the present embodiment, said first parameter is transmitted to said first quantizer after being disposed by said observer. The quantization factor of said first quantizer, said first controller gain and said observer 25 gain are obtained by solving said first linear matrix inequalities and other inequalities constraints. The quantization factor of said first quantizer is updating with change of observational state of said plant in the network, which is transmitted into plant by said observer. The quantization factor information of said first quantizer is transmitted to said second quantizer through network, and the quantization algorithms maybe different. Said first quantizer and said second quantizer is updating with said observational state of said plant in network. Next, the information passing through said first quantizer transmits said first encoder and first decoder. The observational state information of system transmits into said first controller after being quantized and networked. Here, network load capacity and time-delay are considered simultaneously. Therefore, the system states are quantized before they transmit into network and time-delay is considered in the state after they pass through network. The information transmitted into said first controller is the observational sate of plant, wherein quantization and time-delay are considered simultaneously. Next, output signal of said first controller transmits to said second quantizer, and quantization factor of said second quantizer according to said first quantizer transmits to said actuator through said encoder and said decoder in turn, where the quantization factors of two quantizer are different. The output of said actuator transmits into said plant in network, and makes it asymptotically stable.

In the preferable embodiment of the present embodiment, the simulation of the present invention is as follows:

Suppose that the said plant parameters are as follows:

$${A}_{1} = [ \begin{matrix}- 3 & 2 \\ 0 & - 3\end{matrix} ] , {A}_{2} = [ \begin{matrix}- 3 & 0 \\ 0 & - 3\end{matrix} ] , \\ {F}_{1} = {F}_{2} = [ \begin{matrix}0 \\ 0.1\end{matrix} ] , {C}_{1} = [ 0.1 \; 0.1 ] , \\ θ = 1 , {W}_{1} = {W}_{2} = I , τ = 0.02 , \\ {Δ}_{g} = 0.1 , {t}_{k} - {t}_{k - 1} = 0.05 , {Δ}_{1} = {Δ}_{2} = 0.1$$

$${E}_{ki} = [ \begin{matrix}- 1 + {1.2}^{- k} & 0 \\ 0 & - 1 + {1.5}^{- k}\end{matrix} ] .$$

The gain matrices of state feedback controller can be obtained by solving said first linear matrix inequalities and other inequalities

K₁=[0.1315−1.6139], K₂=[0.3701−3.3211].

The observer gain matrices are

$${L}_{1} = [ \begin{matrix}0.7129 \\ 4.3713\end{matrix} ] , {L}_{2} = [ \begin{matrix}- 1.4018 \\ 11.6502\end{matrix} ]$$

The states of system are given by FIG. 3, and it shows the effectiveness of the method proposed by the present invention.

The specific implementation descriptions of the present invention have been given above. It is needed to understand that the invention is not limited to the above specific implementation modalities. The technicians in this field can modify the invention within the scope of the claims. This does not affect the substance of the invention.

1. A method for real-time online control of hybrid nonlinear system characterized in that, it comprises the following steps:
step a. transmitting current observation state information of controlled plant in the network to first controller, wherein said first controller is used to provide real-time online control, which guarantees the asymptotic stability of the controlled plant in the network;
step b. said first controller obtains the current control output information according to the current observation state information;
step c. giving said output control information to said controlled plant in the network as feedback;
wherein said controlled plant in the network is nonlinear hybrid system.

2. The method according to claim 1, characterized in that, it comprises the following steps before said step a:
A. establishing the state space equation of said controlled plant in the network;
B. connecting said first controller and said controlled plant in the network to form a closed loop system.

3. The method according to claim 2, characterized in that, in said closed loop system, the current output information measured is transmitted by said controlled plant in the network to said first controller successively through sensor, observer, first quantizer, first encoder and first decoder, said control output information of said first controller as feedback is transmitted to said controlled plant in the network successively through second quantizer, second encoder, second decoder and actuator, wherein said observer is used to obtain the state information of the system with measurable output of the system, said first quantizer is used to quantize the information which is transmitted in the network from said sensor to said first controller side with the quantization factor, said second quantizer is used to quantize the info nation which is transmitted in the network from said first controller to said actuator side with the quantization factor.

4. The method according to claim 3, characterized in that, said step A comprises the following steps:
getting said first controller gain matrix and said observer gain matrix.

5. The method according to claim 3, characterized in that, said current state information comprises first parameter information, wherein said step a comprises the following steps:
step a1. said first parameter information of said controlled plant in the network is transmitted to said observer through said sensor, wherein said observer is used to observe the state of the controlled plant with the measured output of the system;
step a2. said first parameter information processed by said observer is transmitted to said first quantizer from said observer;
step a3. said first parameter information quantized by said first quantizer is transmitted to said first controller successively through said first encoder and said first decoder from said first quantizer.

6. The methods according to claim 3, characterized in that, said step b comprises the following steps:
step b1. solving first linear matrix inequalities according to said state space equation and said first parameter information, to get the corresponding gain matrices of said first controller and said observer,
step b2. getting the quantization factor change information of said first quantizer according to second inequality constraint, and then transmitting this information to quantization factor of said second quantizer.

7. The method according to claim 3, characterized in that, said step c comprises the following steps:
said control output information quantized by second quantizer is transmitted to said actuator successively through said second encoder and said second decoder.

8. The method according to claim 3, characterized in that, the quantization factor of said first quantizer is different from that of said second quantizer.

9. According to any of the method according to claim 3, characterized in that, said first quantizer is logarithmic quantizer and said second quantizer is time-vary quantizer.

10. The method according to claim 3, characterized in that, said sensor is time driven, and said first controller and said actuator are event driven.

11. The method according to claim 3, characterized in that, said current state information is quantized by said first quantizer, and then part of said current state information is selected to transmit into the network.

12. The method according to claim 3, characterized in that, said first parameter comprises the following parameters:
fuzzy sets;
premise variables for the continuous-time part of the state space equation;
premise variable for the discrete-time part of the sate space equation;
the state space equation of the system;
the control input of the system;
the controlled output of the system;
the impulsive magnitude of the system;
the impulsive instants of the system;
quantization range of the quantizer; and
quantization error of the quantizer.

13. A system for real-time online control of hybrid nonlinear system, comprises first controller, wherein said first controller is used to provide real-time online control, which guarantees the asymptotic stability of the controlled plant in the network characterized in that, it further comprises sensor, observer, first quantizer, first encoder and first decoder, which are connected in series between the output of the controlled plant in the network and the input of said first controller, and it further comprises second quantizer, second encoder, second decoder and said actuator, which are in series connected between the output of said first controller and the input of the controlled plant in the network, wherein said observer is used to observe the state information of the system with the measurable output of the system, said first quantizer is used to quantize the information which is transmitted in the network from said sensor to said first controller side with the quantization factor, said second quantizer is used to quantize the information which is transmitted in the network from said first controller to said actuator side with the quantization factor.

14. The system according to claim 13, characterized in that, said quantization factor of said first quantizer is different from that of said second quantizer.

15. The system according to claim 13, characterized in that, said first quantizer is logarithmic quantizer and said second quantizer is time-vary quantizer.

16. The system according to claim 13, characterized in that, said sensor is time driven, and said first controller and the actuator are event driven.

17. The system according to claim 13, characterized in that, the current state information is quantized by said first quantizer, and then part of said current state information is selected to transmit into the network.

18. The system according to claim 13, characterized in that, said observation state information comprises first parameter, wherein said first parameter comprises the following parameters:
fuzzy sets;
premise variables for the continuous-time part of the state space equation;
premise variable for the discrete-time part of the sate space equation;
the state space equation of the system;
the control input of the system;
the controlled output of the system;
the impulsive magnitude of the system;
the impulsive instants of the system;
quantization range of the quantizer; and
quantization error of the quantizer.

19. The method according to claim 4, characterized in that, said current state information comprises first parameter information, wherein said step a comprises the following steps:
step a1. said first parameter information of said controlled plant in the network is transmitted to said observer through said sensor, wherein said observer is used to observe the state of the controlled plant with the measured output of the system;
step a2. said first parameter information processed by said observer is transmitted to said first quantizer from said observer;
step a3. said first parameter information quantized by said first quantizer is transmitted to said first controller successively through said first encoder and said first decoder from said first quantizer.

20. The methods according to claim 4, characterized in that, said step b comprises the following steps:
step b1. solving first linear matrix inequalities according to said state space equation and said first parameter information, to get the corresponding gain matrices of said first controller and said observer,
step b2. getting the quantization factor change information of said first quantizer according to second inequality constraint, and then transmitting this information to quantization factor of said second quantizer.
